(19) United States
(12) Patent Application Publication
(10) Pub. No.: US 2016/0236489 A1
(43) Pub. Date: Aug. 18, 2016

(54) RECORDING APPARATUS

(71) Applicant: SEIKO EPSON CORPORATION, Tokyo (JP)

(72) Inventors: Yosuke Nakano, Shiojiri-shi (JP); Tomoko Shirai, Suwa-shi (JP); Tetsuya Tamura, Matumoto-shi (JP); Kazuhisa Nakamura, Matumoto-shi (JP)

(21) Appl. No.: 14/993,795

(22) Filed: Jan. 12, 2016

(30) Foreign Application Priority Data
Feb. 17, 2015 (JP) 2015-028642

(51) Int. Cl. B41J 13/03; F16H 1/28

(52) U.S. Cl. CPC B41J 13/03; F16H 1/28

(57) ABSTRACT

When a printer switches a transport driving roller (a motor) from regular rotation to counter rotation in order to perform a skew correction mode, a planetary gear moves toward a mesh position from a separation position. A movement amount of the planetary gear at this time is set to be smaller than a movement amount to reach the mesh position from the separation position. As a result of this, it is possible to prevent a circumstance in which the planetary gear reaches the mesh position during the execution of the skew correction mode, that is, a circumstance in which a driving force is transmitted to a rear feeding device, and a sheet of paper is unintentionally fed from the rear feeding device as a result.

### BACKGROUND

1. Technical Field

The present invention relates to a recording apparatus that performs recording on a recording medium.

2. Related Art

There are cases in which configurations that drive a plurality of paper sheet feeding units with a single driving source (motor) as shown in Japanese Patent No. 4605239, are adopted in a printer. In this case, a driving force transmission switching unit, which is configured by a planetary gear mechanism or the like, is provided between the motor and each paper sheet feeding unit so that a driving force is selectively transmitted to a predetermined paper sheet feeding unit, and the transmission of driving force to the other paper sheet feeding units is interrupted.

In addition, in particular, in a case in which the motor drives a transport roller, which is provided on the downstream side of the paper sheet feeding unit, in addition to the paper sheet feeding unit, it is necessary to set the rotation of a feeding roller of the paper sheet feeding unit to be a single rotation in a state in which the transport roller is rotated continuously, and therefore, there are cases in which a clutch, referred to as a so-called one-time clutch (a single rotation clutch) or the like, is provided (JP-A-2004-231326). Furthermore, even if the rotational direction of the motor switches between regular and counter rotation, for example, there are cases in which a clutch, referred to as a so-called one-way clutch (a single direction clutch) or the like, which transmits a driving force in a regular rotation direction and does not transmit a driving force in a counter rotation direction, is provided (JP-A-2009-250385).

In this instance, the following problems arise in a configuration that selects a paper sheet feeding unit to be driven with switching of the rotational direction of the motor, or more specifically, with the switching of a state of the planetary gear following the switching of the rotational direction of the motor. That is, in a case of performing a skew elimination action, which corrects oblique motion (skew) of a sheet of paper using a transport roller that is provided on the downstream side of the paper sheet feeding unit, it is necessary to switch the transport roller from regular rotation driving to counter rotation driving. At this time, in a case in which, for example, the sheet of paper is fed using a first paper sheet feeding unit (operated by regular rotation of the motor), a driving force is transmitted to a second paper sheet feeding unit (operated by counter rotation of the motor) due to switching of the transport roller (the motor) from regular rotation driving to counter rotation driving, and therefore, there is a concern that a sheet of paper will be unintentionally fed from the second paper sheet feeding unit.

### SUMMARY

An advantage of some aspects of the invention is to prevent driving of a paper sheet feeding unit, the driving of which is not intended, in a configuration that drives a plurality of paper sheet feeding units and a transport roller using a single driving source.

According to a first aspect of the invention, there is provided a recording apparatus including a recording unit that performs recording on a medium, a transport roller that transports the medium, and that rotates in a direction for transporting the medium to a downstream side when a motor is regularly rotated, and rotates in a direction for transporting the medium to an upstream side when the motor is counter rotated, a first feeding unit that is capable of accommodating the medium, and that delivers the medium toward the transport roller when the motor is regularly rotated by obtaining a driving force from the motor, a second feeding unit that is capable of accommodating the medium, and that delivers the medium toward the transport roller when the motor is counter rotated by obtaining a driving force from the motor, a planetary gear mechanism that is configured to include a sun gear which rotates as a result of receiving the driving force of the motor, and a planetary gear which performs planetary motion around the sun gear, and that is configured such that the planetary gear is positioned in a separation position, in which the planetary gear is separated from a transmission gear that transmits a driving force to the second feeding unit, when the motor is regularly rotated, and such that planetary gear is positioned in a mesh position, in which the planetary gear meshes together with the transmission gear, when the motor is counter rotated, and a control unit that controls the rotation time of the motor, in which the control unit is capable of executing a skew correction mode, which causes a leading end of the medium to follow the transport roller by switching from regular rotation of the motor to counter rotation thereof for a predetermined period of time in a feeding mode, which feeds the medium from the first feeding unit, and a movement amount of the planetary gear when the motor is counter rotated for a predetermined period of time is set to be smaller than a movement amount to reach the mesh position from the separation position.

According to the aspect, since the movement amount of the planetary gear when the motor is counter rotated for a predetermined period of time during the execution of the skew correction mode, is set to be smaller than a movement amount to reach the mesh position from the separation position, that is, a movement amount required to switch a driving target from the first feeding unit to the second feeding unit, even if the motor is counter rotated for a predetermined period of time during the skew correction mode, the driving target does not switch from the first feeding unit to the second feeding unit. As a result of this, it is possible to perform suitable feeding control without the medium being unintentionally sent from the second feeding unit during the skew correction mode.

In the recording apparatus of a second aspect of the invention, the first feeding unit may have a configuration that delivers the medium from a medium accommodation section, which accommodates the medium in a substantially flat manner, and the second feeding unit may have a configuration that delivers the medium from a medium setting section, in which the medium is set with an inclined posture.

According to the aspect, it is possible to obtain the functional effect of the abovementioned first aspect in a configuration in which the first feeding unit has a configuration that delivers the medium from a medium accommodation section, which accommodates the medium in a substantially flat manner, and the second feeding unit delivers the medium from a medium setting section, in which the medium is set with an inclined posture.

The recording apparatus of a third aspect of the invention may further include a carriage that is provided with the recording unit, and that is capable of moving in a direction that intersects a transport direction of the medium, and a switching unit that switches between a transmission state in which the rotation of the motor is transmitted to the first feeding unit and the second feeding unit by engaging with the carriage, and an interruption state in which the transmission is interrupted, and the control unit may be provided with a normal feeding mode, which performs state switching of the switching unit each time a sheet of the medium is delivered from the first feeding unit by performing state switching of the switching unit via the carriage, and a continuous feeding mode, which continuously delivers a plurality of sheets of the medium from the first feeding unit while retaining the switching unit in the transmission state.

According to the aspect, driving force transmission from the motor to the first feeding unit and the second feeding unit is retained in the continuous feeding mode (however, the driving of the second feeding unit depends on the rotational direction of the motor due to the planetary gear mechanism). Accordingly, the planetary gear moves toward the mesh position from the separation position when the skew correction mode is executed during feeding of the medium from the first feeding unit, but as a result of the abovementioned first aspect, the driving target does not switch from the first feeding unit to the second feeding unit. As a result of this, in the continuous feeding mode, it is possible to perform suitable feeding control without the medium being unintentionally sent from the second feeding unit during the skew correction mode.

In the recording apparatus of a fourth aspect of the invention, the second feeding unit may be provided with a feeding roller that delivers the medium, a hopper that supports the medium in an inclined posture, that is capable of switching between a state in which the feeding roller comes into pressure contact with the medium as a result of swinging, and a state in which the medium is separated from the feeding roller, and that configures the medium setting section, a cam that engages with the hopper and rotates by obtaining a driving force from the transmission gear, and that executes state switching of the hopper a single time during a single rotation action, and a gear group that transmits a driving force from the transmission gear to the feeding roller, and that causes the feeding roller to rotate a plurality of times during a single rotation action of the cam.

According to the aspect, since the recording apparatus has a configuration that rotates the feeding roller a plurality of times during a single rotation action of the cam, it is possible to reduce the diameter of the feeding roller, and therefore, it is possible to achieve miniaturization of the apparatus.

In the recording apparatus of a fifth aspect of the invention, the second feeding unit may be provided with a feeding roller that delivers the medium, a rotational shaft on which the feeding roller is provided, and a clutch that allows idling of the feeding roller with respect to the rotational shaft when the medium that is delivered from the second feeding unit is transported to the downstream side by the transport roller.

According to the aspect, since the recording apparatus is provided with the clutch that allows idling of the feeding roller with respect to the rotational shaft when the medium that is delivered from the second feeding unit is transported to the downstream side by the transport roller, it is possible to eliminate or reduce a load that the feeding roller applies to the medium when the medium that is delivered from the second feeding unit is transported to the downstream side by the transport roller, and therefore, it is possible to suitably perform medium transport using the transport roller.

### BRIEF DESCRIPTION OF THE DRAWINGS

The invention will be described with reference to the accompanying drawings, wherein like numbers reference like elements.

FIG. 1 is an external perspective view of a printer according to the invention.

FIG. 2 is a lateral cross-sectional view that shows a paper sheet transport pathway of the printer according to the invention.

FIG. 3 is a perspective view of a pathway that transmits a driving force from a transport driving roller to a front feeding device and a rear feeding device.

FIG. 4 is a perspective view of a pathway that transmits a driving force from the transport driving roller to the front feeding device and the rear feeding device.

FIG. 5 is a perspective view of a pathway that transmits a driving force from the transport driving roller to the front feeding device and the rear feeding device.

FIG. 6 is a perspective view of a pathway that transmits a driving force from the transport driving roller to the front feeding device and the rear feeding device.

FIG. 7 is a perspective view of a switching unit that switches between a state in which the rotation of the transport driving roller is transmitted by engaging with a carriage, and a state in which the transmission is interrupted.

FIG. 8 is a perspective view of a switching unit that switches between a state in which the rotation of the transport driving roller is transmitted by engaging with the carriage, and a state in which the transmission is interrupted.

FIG. 9 is a front view of a planetary gear mechanism.

FIG. 10 is a perspective view of the rear feeding device.

FIG. 11 is a perspective view of a driving mechanism section in the rear feeding device.

FIG. 12 is a perspective view of a clutch that is provided between a feeding roller and a rotational shaft of the rear feeding device.

FIG. 13 is a perspective view of the clutch that is provided between the feeding roller and the rotational shaft of the rear feeding device.

FIG. 14 is a lateral cross-sectional view of the rear feeding device.

FIG. 15 is a view that shows an embodiment of the clutch.

FIG. 16 is a view that shows another embodiment of the clutch.

### DESCRIPTION OF EXEMPLARY EMBODIMENTS

Hereinafter, an embodiment of the invention will be described on the basis of the drawings, but the invention is not limited to the embodiment described below, various modifications are possible within the range of the invention that is set forth in the claims, and the following embodiment of the invention will be described on the premise that such modifications are also included within the range of the invention.

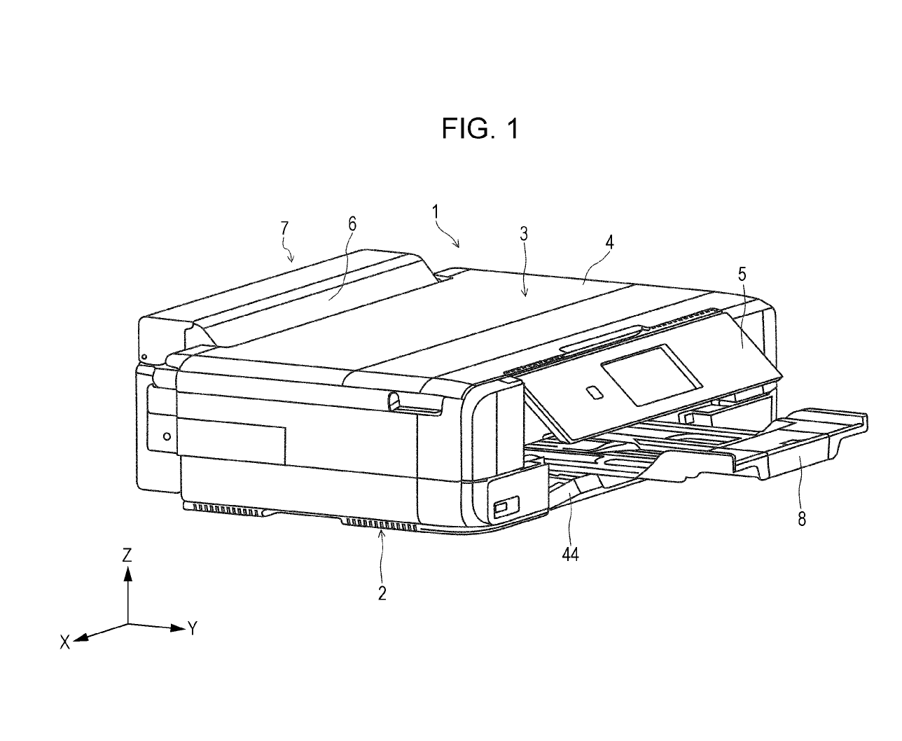

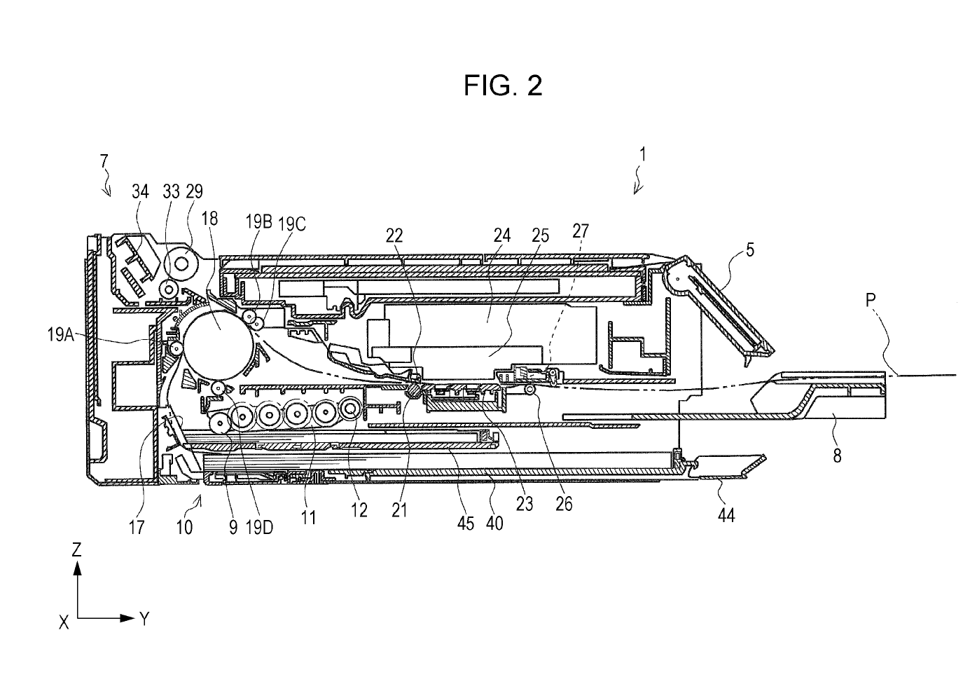

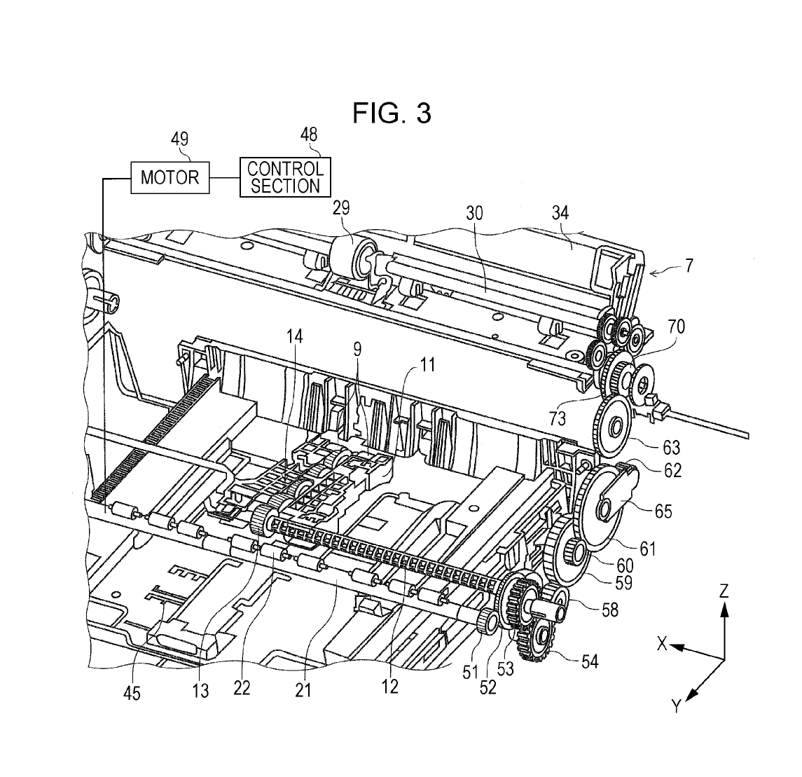

FIG. 1 is an external perspective view of a printer 1 according to the invention, FIG. 2 is a lateral cross-sectional view that shows a paper sheet transport pathway of the printer 1, and FIGS. 3 to 6 are perspective views of a pathway that transmits a driving force from a transport driving roller 21 to a front feeding device 10 and a rear feeding device 7.

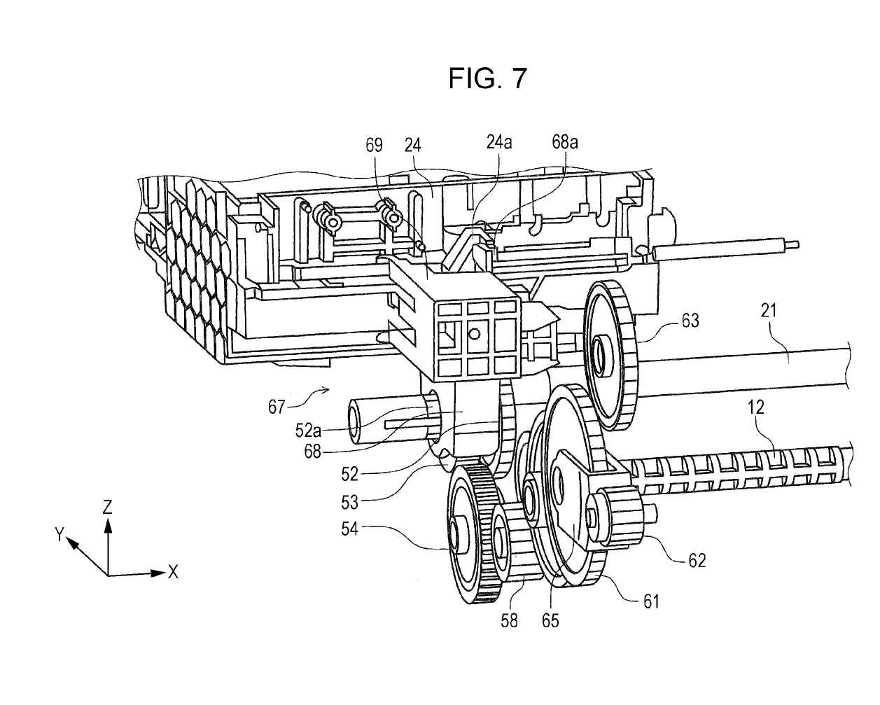

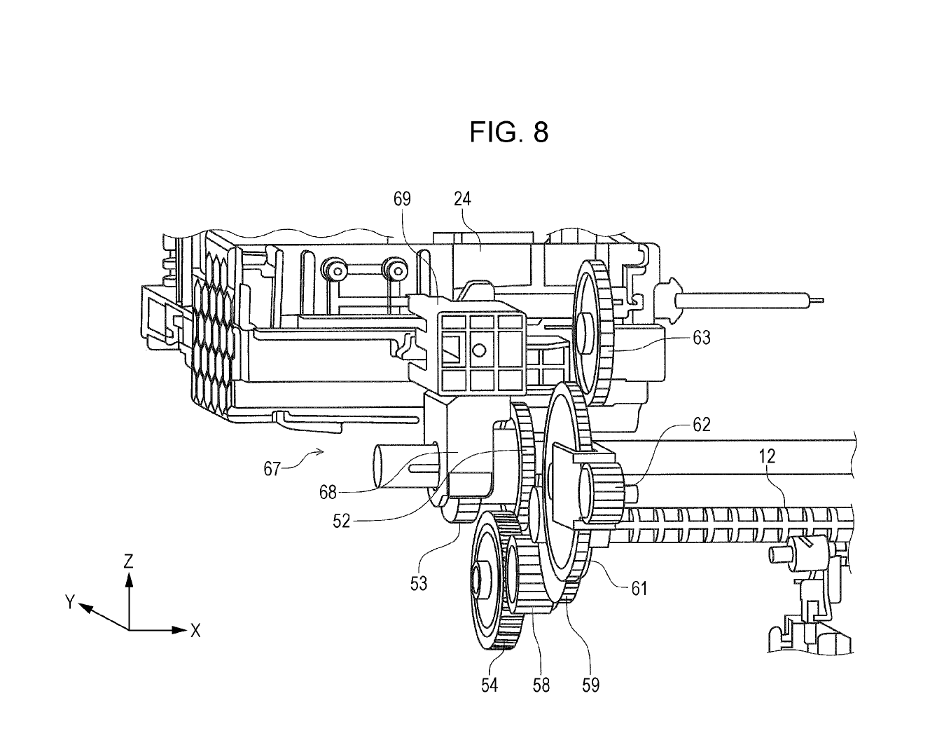

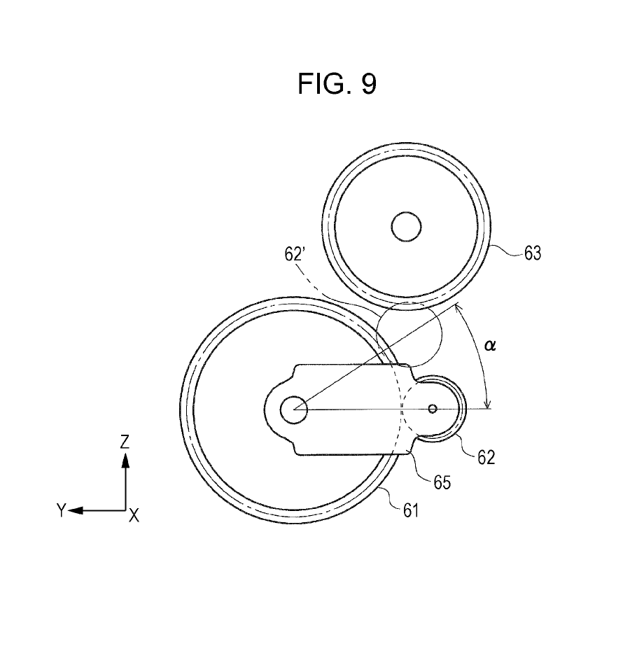

In addition, FIGS. 7 and 8 are perspective views of a switching unit 67 that switches between a state in which the rotation of the transport driving roller 21 is transmitted by engaging with a carriage 24, and a state in which the transmission is interrupted, and FIG. 9 is a front view of a planetary gear mechanism.

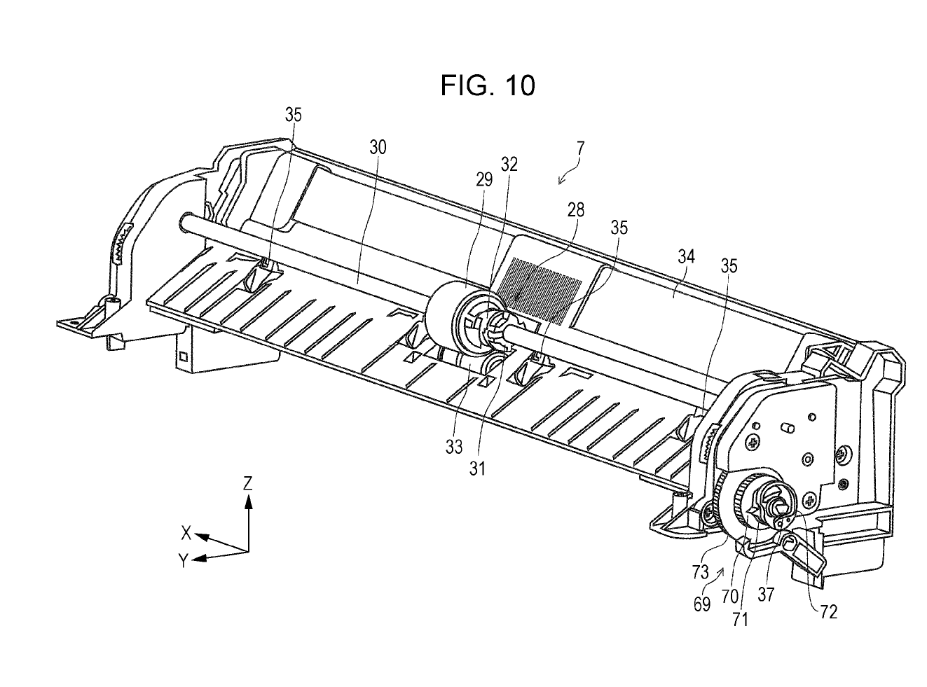

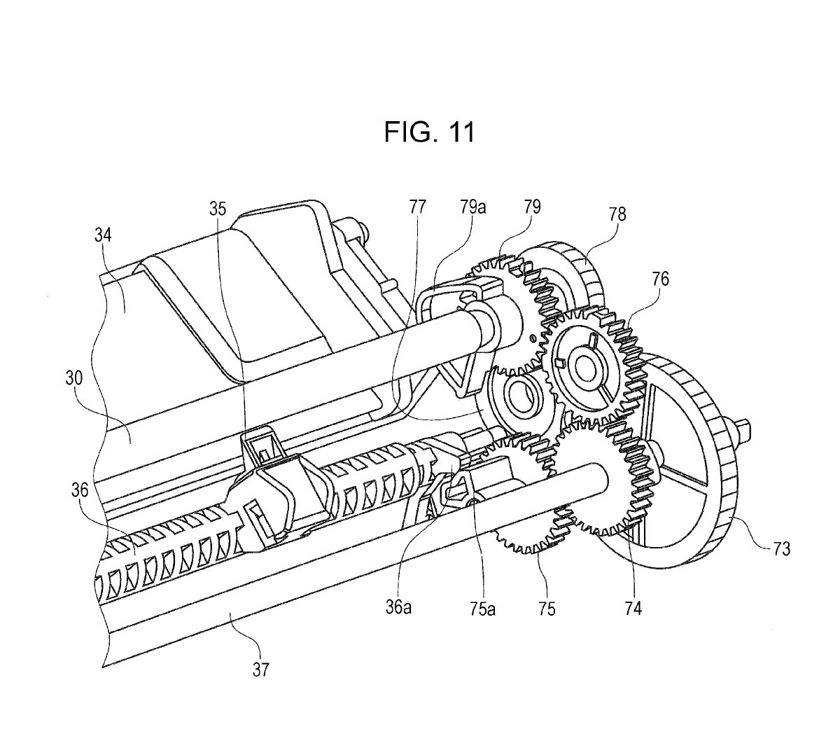

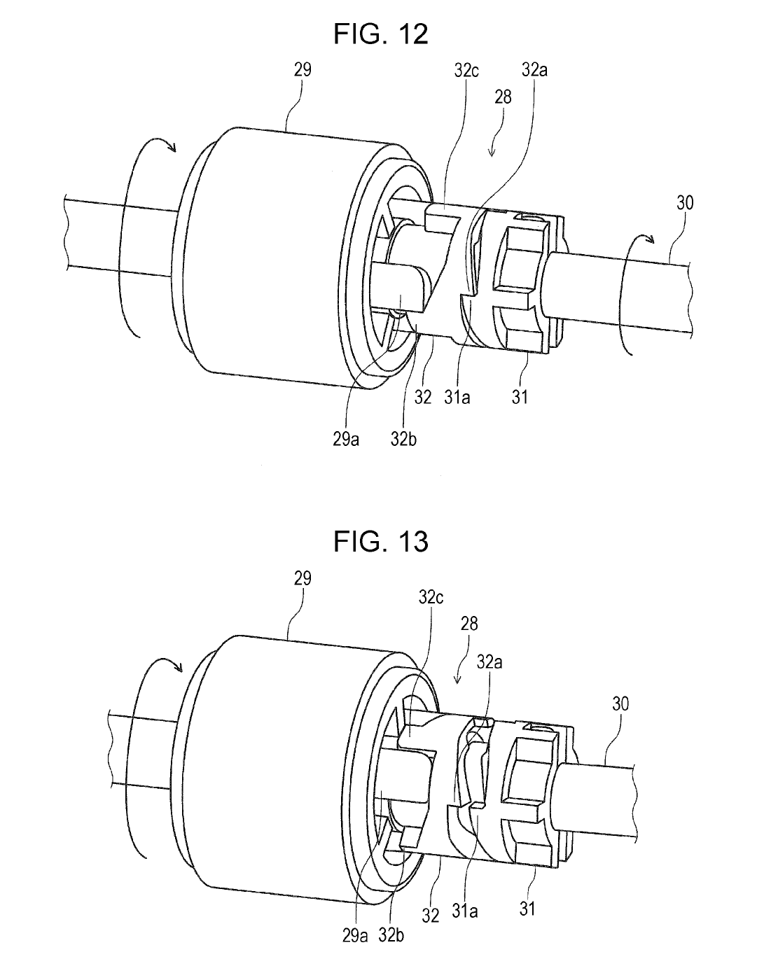

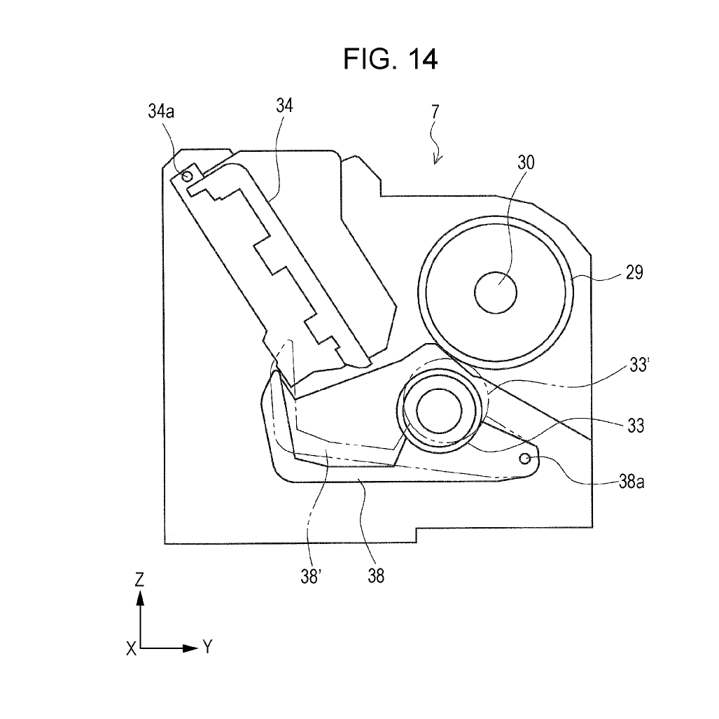

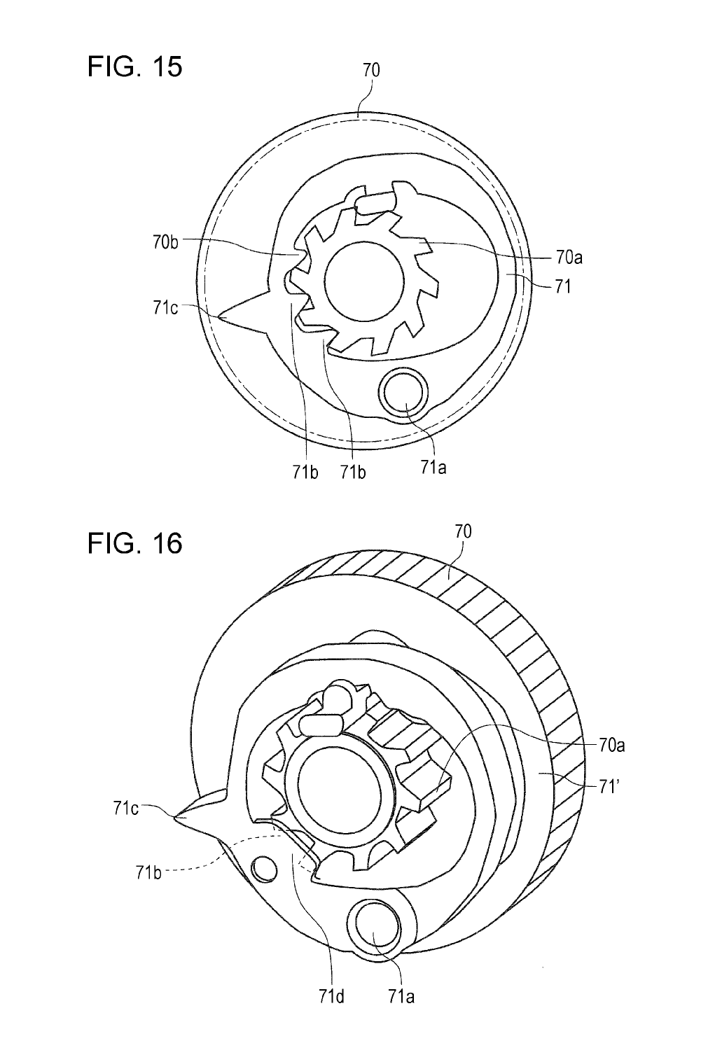

Furthermore, FIG. 10 is a perspective view of the rear feeding device 7, FIG. 11 is a perspective view of a driving mechanism section in the rear feeding device 7, FIGS. 12 and 13 are perspective views of a clutch that is provided between a feeding roller 29 and a rotational shaft 30 of the rear feeding device 7 (a one-way latch mechanism 28). Furthermore, FIG. 14 is a lateral cross-sectional view of the rear feeding device 7, and FIGS. 15 and 16 are views that show an embodiment of a clutch 67.

Additionally, an x-y-z coordinate system in each drawing shows directions, and a z direction shows a vertical direction (an apparatus height direction), a y direction shows a paper sheet transport and ejection direction (an apparatus front-back direction), and an x direction shows a paper sheet width direction (an apparatus left-right direction).

### 1. Overall Configuration of Printer

Hereinafter, an overall configuration of the printer 1, which is an embodiment of a recording apparatus of the invention, will be outlined with reference to FIGS. 1 and 2. The printer 1 is provided with a scanner unit 3 above an apparatus main body (a recording section) 2 that performs ink jet recording on recording paper sheets, as an example of a medium, that is, is configured as a multifunction machine that is provided with a scanning function in addition to an ink jet recording function.

The scanner unit 3 is provided to be capable of revolving with respect to the apparatus main body 2, and can have a closed state (FIG. 1) or an open state (not illustrated in the drawings) as a result of being revolved.

A cover 4, which is above the scanner unit 3, is a cover that is capable of opening and closing, and a manuscript stand (not illustrated in the drawings) of the scanner unit 3 is displayed by opening the cover 4.

The reference numeral 5 on the front surface of the apparatus is an operational panel that is provided with a power button, operation buttons, which perform various printing settings and the execution of recording, a display section, which performs preview display of printing settings content and printing images, and the like.

In addition, the reference numeral 44 on the front surface of the apparatus is a cover, in which a lower stage side tray 40 is provided, and which is capable of opening and closing, and, as shown in FIG. 1, is configured so that the lower stage side tray 40, an upper stage side tray 45 and a paper ejection reception tray 8, as a medium accommodation tray, are exposed as a result of opening the cover 44. The lower stage side tray 40 and the upper stage side tray 45 configure a front feeding device 10 (FIG. 2), as “a first feeding unit”, and are an accommodation section that accommodates sheets of paper.

The paper ejection reception tray 8 is provided to be able to take on a state (not illustrated in the drawings) of being accommodated in the apparatus main body 2, and a state (FIG. 1) of protruding on a front side of the apparatus main body 2 as a result a motor, which is not illustrated in the drawings, and as a result of attaining the state of protruding on the front side of the apparatus main body 2, can receive recording paper sheets that are ejected due to recording being performed.

The lower stage side tray 40 and the upper stage side tray 45, which are capable of accommodating a plurality of recording paper sheets, are a medium accommodation section that accommodates a medium, that is, the medium accommodation section of the printer 1 is configured by a plurality of medium accommodation sections. The lower stage side tray 40 and the upper stage side tray 45, which is provided above the lower stage side tray 40, are respectively independently detachable from the apparatus main body 2. In addition, even if one of the lower stage side tray 40 and the upper stage side tray 45 is in an unmounted state, as long as the other is mounted, it is possible to deliver recording paper sheets from the corresponding tray that is mounted.

Additionally, in a state in which the upper stage side tray 45 is mounted in the apparatus main body 2, the upper stage side tray 45 is provided between a standby position (not illustrated in the drawings), and an abutting position (a position in which feeding is possible: FIG. 1) in a manner in which the upper stage side tray 45 performs sliding displacement due to a tray driving unit, which is not illustrated in the drawings. For example, when a printing job, which supplies from the upper stage side tray 45, is executed, a control section (not illustrated in FIGS. 1 and 2) of the printer 1 positions the upper stage side tray 45 in the abutting position that is shown in FIG. 2. In addition, when a printing job, which supplies from the lower stage side tray 40, is executed, a control section 48 of the printer 1 positions the upper stage side tray 45 in a retreat position (not illustrated in the drawings).

The printer 1 is provided with a tray position detection sensor (not illustrated in the drawings) that detects a sliding position of the upper stage side tray 45, and the control section of the printer 1 can ascertain whether or not the upper stage side tray 45 is in the position in which feeding is possible or in the retreat position on the basis of signal information that is sent from the corresponding tray position detection sensor. However, in the present embodiment, since the upper stage side tray 45 is driven by a motor, it is possible to ascertain whether or not the abutting position of the upper stage side tray 45 is either side (a side of the position in which feeding is possible or a side of the retreat position) by increasing a current value of the motor on the basis of a motor driving direction.

Subsequently, the reference numeral 6 in a rear upper section of the apparatus main body 2 is a cover that is capable of opening and closing, and the feeding of recording paper sheets, which uses the rear feeding device 7, as “a second feeding unit”, is performed by opening the cover 6.

Next, a paper sheet transport pathway of the printer 1 will be described with reference to FIG. 2. As described above, the printer 1 according to the present embodiment is provided with a plurality of paper sheet feeding devices, that is, the front feeding device 10, as the “first feeding unit”, and the rear feeding device 7, as the “second feeding unit”. The front feeding device 10 has a configuration that delivers sheets of paper from the lower stage side tray 40 and the upper stage side tray 45, which are medium accommodation sections that accommodate sheets of paper in a substantially flat manner, and the rear feeding device 7 has a configuration that delivers sheets of paper from a hopper 34, as a medium setting section, in which sheets of paper are set with an inclined posture.

Firstly, in the front feeding device 10, a feeding roller 9, which is rotationally driven by a motor 49 (FIG. 3), as a driving source, is provided on the roller support member 11 as a swinging member, which swings with a rotational shaft 12 as the center thereof, and when the upper stage side tray 45 is in the retreat position, delivers a topmost sheet of paper, which is accommodated in the lower stage side tray 40, from the lower stage side tray 40 by rotating in contact with the corresponding topmost sheet of paper.

In addition, when the upper stage side tray 45 is in the abutting position (the position in which feeding is possible: FIG. 2), the feeding roller 9 delivers a topmost sheet of paper, which is accommodated in the upper stage side tray 45, from the upper stage side tray 45 by rotating in contact with the corresponding topmost sheet of paper.

Additionally, in the present embodiment, the rotational shaft 12 configures a swinging axis of a roller support member 11, and transmits a driving force from a transmission gear 13, which, as shown in FIG. 3, is provided on the rotational shaft 12, to a target transmission gear (not illustrated in the drawing), which is provided integrally with the feeding roller 9, via a gear train row 14 by receiving a driving force of the motor 49 (FIG. 3) and rotating. The rotational shaft 12 also simultaneously transmits a driving force for causing the roller support member 11 to swing when transmitting the driving force for causing the feeding roller 9 to rotate. In a case on which the feeding roller 9 rotates in a direction that delivers sheets of paper, a swinging force is applied to the roller support member 11 in the anticlockwise direction (a direction on which the feeding roller 9 comes into contact with a sheet of paper) in FIG. 2. Additionally, in the present embodiment, the feeding roller 9 is provided on both sides of the gear train row 14 with the gear train row 14 interposed therebetween.

A separation inclined surface 17 is provided in a position that faces a leading end of the lower stage side tray 40 and the upper stage side tray 45, and separation of the topmost sheet of paper P, which should be fed, and a subsequent sheet of paper P is performed as a result of leading ends of sheets of paper P that are delivered from the lower stage side tray 40 or the upper stage side tray 45 proceeding to a downstream side while in contact with the separation inclined surface 17.

An intermediate roller 18, which is rotationally driven by a motor, which is not illustrated in the drawings, is provided at a front end of the separation inclined surface 17, and the sheets of paper are curved and inverted by the intermediate roller 18, and move toward an apparatus front side. Additionally, the reference numerals 19A, 19B and 19C are driven rollers, which are capable of being driven to rotate, and at least the sheets of paper are sent to the downstream side as a result of being nipped by the driven roller 19A and the intermediate roller 18, and nipped by the driven roller 19B and the intermediate roller 18.

Subsequently, in the rear feeding device 7, the reference numeral 34 is a hopper, the reference numeral 29 is a feeding roller, and the reference numeral 33 is a separation roller. In this case, when the rear feeding device 7 is described with reference to FIG. 14, the hopper 34 is capable of swinging with a swinging pivot point 34a of an upper section as a center thereof, and causes the feeding roller 29 to come into pressure contact with sheets of paper that are supported in an inclined posture or separates the feeding roller 29 from the sheets of paper that are supported in an inclined posture as a result of swinging. The feeding roller 29 is provided on the rotational shaft 30, and the rotational shaft 30 is rotationally driven by the motor 49 (FIG. 3). Additionally, a paper support for extending a paper sheet support surface of the hopper 34 upward is provided on a back surface side of the hopper 34, but description thereof will be omitted.

The separation roller 33 is provided in a holder 38, which swings with a swinging axis 38a as the center thereof, and is capable of rotating in a state in which rotational resistance is being applied thereto. The holder 38 is engaged with the hopper 34, as shown by the solid lines in FIG. 14, is pushed down toward a lower section when the hopper 34 is in a descended posture (a posture in which the sheets of paper are separated from the feeding roller 29), and the separation roller 33 is separated from the feeding roller 29. In contrast to this, when the hopper 34 is in a raised posture (a posture in which the sheets of paper are in pressure contact with the feeding roller 29), the holder 38 is pushed up toward an upper section (the virtual lines and reference numeral 38′ in FIG. 14) by a biasing force of a biasing unit, which is not illustrated in the drawing, and as a result of this, the separation roller 33 comes into contact with the feeding roller 29 (the virtual lines and reference numeral 33′ in FIG. 14).

In a state in which the separation roller 33 is in contact with the feeding roller 29 a topmost sheet of paper that should be fed receives a transport force from the feeding roller 29, is delivered from between the two rollers, and multifeed is prevented as a result of a subsequent sheet of paper, for which there is a concern of multifeeding, remaining in a nipped position between the separation roller 33 and the feeding roller 29. Additionally, the sheet of paper P that remains in the nipped position between the separation roller 33 and the feeding roller 29 is returned to the top of the hopper 34 as a result of a paper sheet return lever 35 (FIGS. 10 and 11).

The sheet of paper P that is delivered by the feeding roller 29 receives the transport force from the intermediate roller 18 in the same manner as the sheets of paper P that are delivered from the front feeding device 10, and is transported toward the transport driving roller 21.

The abovementioned hopper 34 and the paper sheet return lever 35 are driven by the driving force of the motor 49 (FIG. 3), but this feature will be described later.

Returning to FIG. 2, the transport driving roller 21, which is driven by a motor, which is not illustrated in the drawings, and a transport driven roller 22, which is driven to rotate by being in contrast to the transport driving roller 21, are provided at a front end of the intermediate roller 18, and sheets of paper are sent below a recording head 25, which configures the recording unit, by these rollers.

Subsequently, the recording head 25, which discharges an ink, is provided in a bottom section of the carriage 24, and the carriage 24 is driven to reciprocate in a main scanning direction (a paper surface front and back direction in FIG. 2) by a motor, which is not illustrated in the drawings.

A support member 23 is provided in a position that faces the recording head 25, and an interval between sheets of paper and the recording head 25 is defined by the support member 23. Further, an ejection driving roller 26, which is driven by a motor, which is not illustrated in the drawings, and an ejection driven roller 27, which is driven to rotate as a result of being in contact with the ejection driving roller 26, are provided on a downstream side of the support member 23. The sheets of paper on which recording has been performed by the recording head 25 are ejected toward the paper ejection reception tray 8 that was mentioned above, by these rollers.

In the present embodiment, the feeding roller 9 (the front feeding device 10), the feeding roller 29 (the rear feeding device 7), the intermediate roller 18, the transport driving roller 21, and the ejection driving roller 26 a driven by a single motor (the motor 49: FIG. 3), and furthermore, the motor 49 is controlled by a control section 48 (FIG. 3). In addition, the motor (not illustrated in the drawings) that drives the carriage 24, and the recording head 25 are also controlled by the control section 48.

### 2. Driving Force Transmission Pathway

Next, a driving force transmission pathway that transmits a driving force from the motor 49 to the front feeding device 10 and the rear feeding device 7 will be described with reference to the drawings form FIG. 3 onward.

In FIG. 3, the motor 49 drives the transport driving roller 21, and the front feeding device 10 and the rear feeding device 7 obtain the driving force of the motor 49 via the transport driving roller 21.

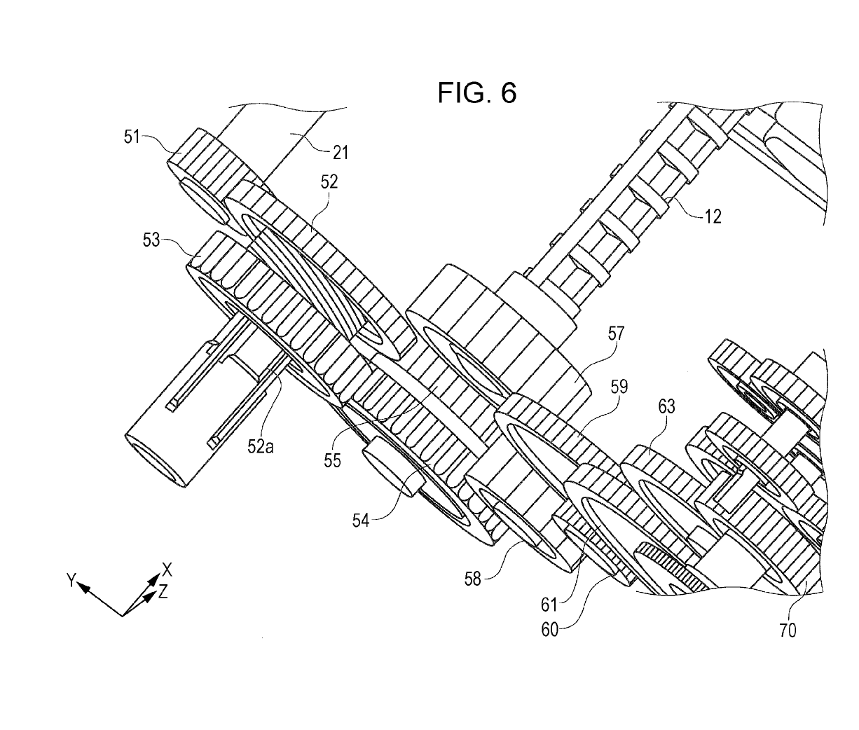

In FIGS. 3 to 9, the reference numerals 51 to 63 all show gears, and a driving force is transmitted from the gear 51, which is provided at an axial end of the transport driving roller 21 to ward each feeding device. As is also shown in FIG. 6, a gear 52 meshes together with the gear 51. The gear 52 includes a shaft section 52a, and the gear 53 fits together with the shaft section 52a in a manner in which the gear 53 is capable of sliding in a rotational axis line direction (the x direction). Additionally, although the gear 53 is capable of sliding in the rotational axis line direction (the x direction) with respect to the gear 52, the gear 53 fits together with the shaft section 52a in a manner in which the gear 53 rotates integrally with the gear 52.

In this instance, the gear 53 can be switched between a state (FIG. 7) of meshing together with the gear 54, and a state (FIG. 8) of not meshing together with (being separated from) the gear 54 by the switching unit 67 (FIGS. 7 and 8). In FIGS. 7 and 8, the switching unit 67 is provided with a holder member 68 and a face cam accommodation section 69. The holder member 68 is a member that causes sliding displacement of the gear 53, and includes an engagement section 68a that is capable of engaging with the carriage 24.

A face cam (not illustrated in the drawings) is accommodated in the face cam accommodation section 69, and a position of the holder member 68, that is, a position of the gear 53, is held by the face cam. Additionally, the face cam is a publicly-known face cam.

As shown in FIGS. 7 and 8, when the carriage 24 moves to a home position, the carriage 24 engages with the engagement section 68a of the holder member 68, and the holder member 68, that is, the gear 53, is displaced. Even if the carriage 24 is separated from the home position thereafter, the holder member 68, that is, the gear 53, can be held in a displaced position by the abovementioned face cam, which is not illustrated in the drawings. In the abovementioned manner, by engaging with the carriage 24, the switching unit 67 switches the rotation of the motor 49 between a transmission state (FIGS. 6 and 7) in which transmission to the front feeding device 10 and the rear feeding device 7 is possible, and an interruption state (FIG. 8) in which the transmission is interrupted.

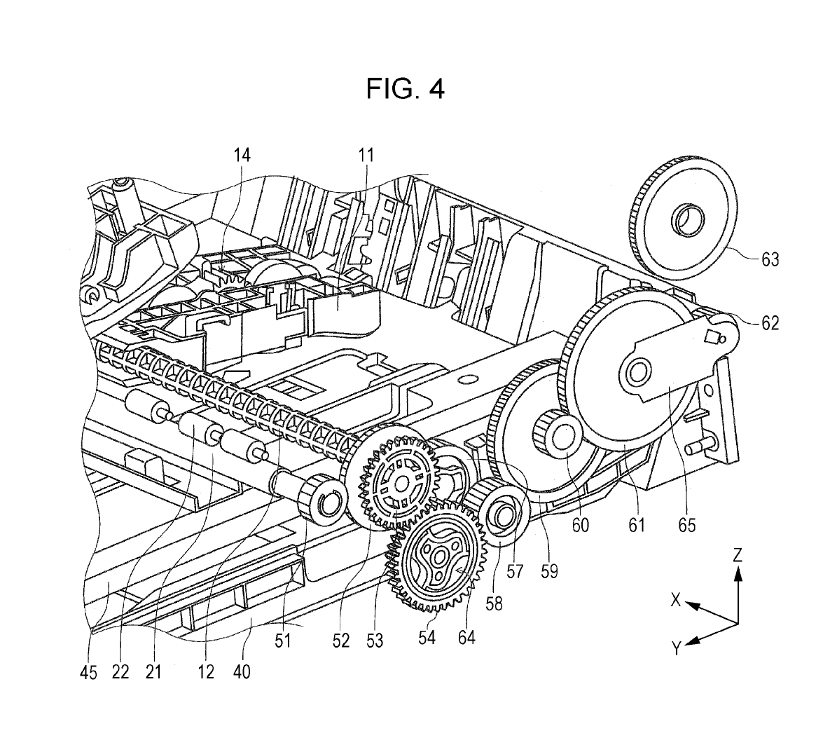

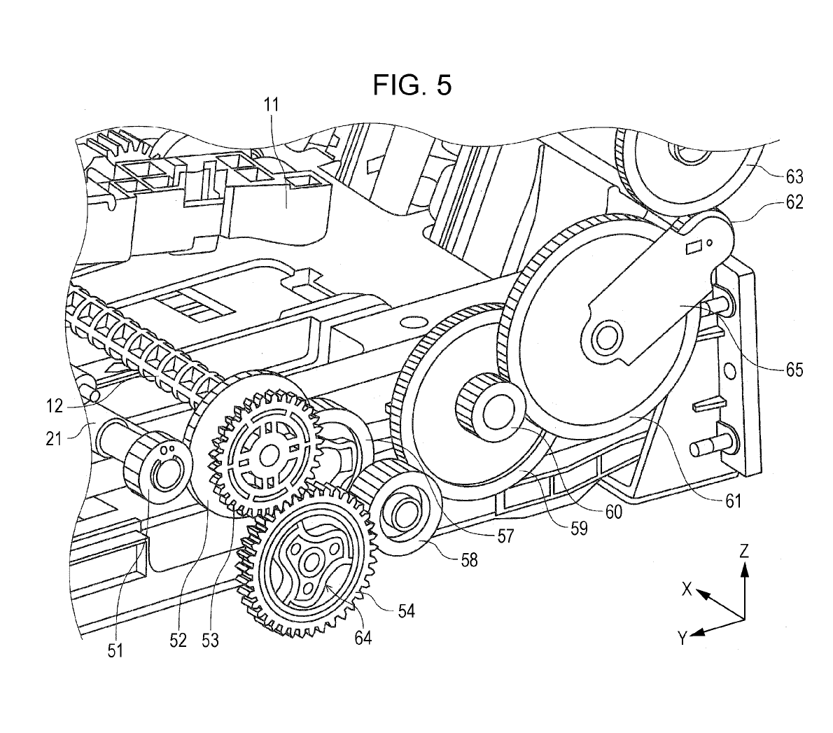

Returning to FIG. 6, a one-way clutch mechanism 64 (FIGS. 4 and 5) is provided on an inner side of the gear 54, and a driving force is transmitted from the gear 54 to the gear 55 via the one-way clutch mechanism 64. Additionally, FIGS. 4 and 5 are cross-sectional perspective views of the gear 54, but hatching is omitted in order to simplify the drawings.

The gear 55 meshes together with the gear 57, which is provided at an axial end of the rotational shaft 12 (the shaft that transmits a driving force to the feeding roller 9), that is, the rotational shaft 12 obtains a driving force of the gear 51 (the motor 49) via the one-way clutch mechanism 64. The one-way clutch mechanism 64 is a clutch that only transmits the driving force of the gear 51 (the motor 49) to the gear 55 during rotation in one direction, and in the present embodiment, transmits torque to the gear 55 during regular rotation of the motor 49, that is, during rotation in which the gear 51 transports sheets of paper to the downstream side (during regular rotation of the transport driving roller 21). As a result of this, during regular rotation of the motor 49, the rotational shaft 12, that is, the feeding roller 9 (the front feeding device 10) rotates regularly, and delivers sheets of paper to the downstream side. Further, during counter rotation of the motor 49 (during counter rotation of the transport driving roller 21), a driving force of the motor 49 is not transmitted to the rotational shaft 12, that is, the feeding roller 9 (the front feeding device 10). Since the one-way clutch mechanism 64, which exhibits the abovementioned function, is a publicly-known, general one-way clutch mechanism, detailed description thereof will be omitted.

Meanwhile, the gear 54 itself always rotates when the motor 49 (the transport driving roller 21) rotates, and a driving force is transmitted from the gear 54 to a sun gear 61 via the gear 58, the gear 59 and the gear 60. A planetary gear 62 meshes together with the sun gear 61, as shown in FIGS. 3 to 5, the planetary gear 62 is supported by a holder 65, and performs planetary motion around the sun gear 61 depending on switching of the transmission direction of the sun gear 61. The planetary gear 62 is displaced between a mesh position (FIG. 5) of meshing together with a transmission gear 63, which transmits a driving force to the rear feeding device 7, and a separation position (FIG. 4) of being separated from the gear 63, as a result of planetary motion.

When the planetary gear 62 is in the separation position, a driving force of the motor 49 (the transport driving roller 21) is not transmitted to the driving force transmission pathway after the transmission gear 63, that is, the rear feeding device 7. In this instance, during regular rotation of the motor 49 (the transport driving roller 21), the sun gear 61 rotates in the clockwise direction in FIGS. 4 and 5, and the planetary gear 62 is positioned in the separation position (FIG. 4). Additionally, positional restriction of the separation position of the planetary gear 62 is performed as a result of the holder 65 abutting against a restriction section, which is not illustrated in the drawings.

Further, when the motor 49 (the transport driving roller 21) is switched to counter rotation from this state, the sun gear 61 rotates in the anticlockwise direction in FIGS. 4 and 5, the planetary gear 62 is displaced to the mesh position (FIG. 5) as a result, and therefore, a driving force is transmitted to the rear feeding device 7. Additionally, in a case of driving the rear feeding device 7, the rotation speed of the motor 49 is set to be slower than a case of driving the front feeding device 10. As a result of this, in particular, it is possible to reliably retain the meshing together of the planetary gear 62 and the transmission gear 63.

If the abovementioned configuration is summarized, in a mesh state of the gear 53 and the gear 54, during regular rotation of the motor 49 (the transport driving roller 21), a driving force is transmitted to the front feeding device 10, and sheets of paper are delivered from the front feeding device 10. At this time, a driving force is not transmitted to the rear feeding device 7.

In contrast to this, during counter rotation of the motor 49 (the transport driving roller 21), a driving force is transmitted to the rear feeding device 7, and sheets of paper are delivered from the rear feeding device 7. At this time, a driving force is not transmitted to the front feeding device 10.

Subsequently, the setting of a displacement amount of the planetary gear 62 from the separation position to the mesh position will be described. Firstly, a control mode, which the control section 48 executes, will be described.

The control section 48 is provided with a normal feeding mode, which performs state switching of the switching unit 67 (FIGS. 7 and 8) by driving the carriage 24 for each sheet of paper that is delivered when sheets of paper are delivered from the front feeding device 10, and a continuous feeding mode, which continuously delivers a plurality of sheets of paper from the front feeding device 10 without causing the carriage 24 to engage with the switching unit 67 while retaining the switching unit 67 in the transmission state (FIG. 7).

In addition, in the abovementioned normal feeding mode and the continuous feeding mode, the control section 48 is capable of executing a skew correction mode, which causes a leading end of a sheet of paper to follow a nipped position between the transport driving roller 21 and the transport driven roller 22 by switching the rotation of the motor 49 from regular rotation to counter rotation thereof for a predetermined period of time. That is, the skew correction mode is a mode that corrects skew by switching the transport driving roller 21 from regular rotation to counter rotation before a leading end of a sheet of paper passes the intermediate roller 18 and reaches the transport driving roller 21 and the transport driven roller 22, and causing the leading end of the sheet of paper to abut between the transport driving roller 21 and the transport driven roller 22.

In this instance, when the transport driving roller 21 (the motor 49) is switched from regular rotation to counter rotation, the planetary gear 62 moves toward the mesh position (FIG. 5) from the separation position (FIG. 4). At this time, if the planetary gear 62 moves to the mesh position (FIG. 5), a driving force is transmitted to the rear feeding device 7, and a sheet of paper is unintentionally fed from the rear feeding device 7 as a result.

In such an instance, in the present embodiment, a movement amount of the planetary gear 62 when the motor 49 is counter rotated for a predetermined period of time is set to be smaller than a movement amount to reach the mesh position (FIG. 5) from the separation position (FIG. 4).

In FIG. 9, the reference numeral a shows a swing angle of the holder 65 (the planetary gear 62) of the planetary gear 62 moving from the separation position (the reference numeral 62 and the solid line) to the mesh position (the reference numeral 62′ and the virtual line). In the skew correction mode, a swing angle of the holder 65 (the planetary gear 62) when the motor 49 is counter rotated for a predetermined period of time is set to be smaller than the angle α.

As a result of the above, even if the motor 49 is counter rotated for a predetermined period of time during execution of the skew correction mode, the driving target does not switch from the front feeding device 10 to the rear feeding device 7. As a result of this, it is possible to perform suitable feeding control without a sheet of paper from the rear feeding device 7 being unintentionally sent during the skew correction mode.

Additionally, the abovementioned counter rotation of the motor 49 for a predetermined period of time can be managed by a pulse number (a step number) that is delivered from an encoder, which determines the rotation of the motor 49, and which is not illustrated in the drawings.

The following is a summary of the configuration of the invention that is described above. The printer 1 is provided with the recording head 25, as a recording unit that performs recording on sheets of paper, and a transport driving roller 21 which transports sheets of paper, and which rotates in a direction that transports the sheets of paper to a downstream side when the motor 49 is regularly rotated, and rotates in direction that transports the sheets of paper to an upstream side when the motor 49 is counter rotated. In addition, the printer 1 is provided with the front feeding device 10, which is capable of accommodating the sheets of paper, and which delivers the sheets of paper toward the transport driving roller 21 when the motor 49 is regularly rotated by obtaining a driving force from the motor 49 (the transport driving roller 21), and the rear feeding device 7, which is capable of accommodating the sheets of paper, and which delivers the sheets of paper toward the transport driving roller 21 when the motor 49 (the transport driving roller 21) is counter rotated by obtaining a driving force from the motor 49 (the transport driving roller 21).

In addition, the printer 1 is provided with the sun gear 61, which rotates as a result of receiving the driving force of the motor 49 (the transport driving roller 21), and the planetary gear 62 that performs planetary motion around the sun gear 61. Further, the printer 1 is provided with a planetary gear mechanism that is provided with a configuration that is positioned in a separation position, in which the planetary gear 62 is separated from the transmission gear 63 that transmits a driving force to the rear feeding device 7, when the motor 49 (the transport driving roller 21) is regularly rotated, and that is positioned in a mesh position, in which the planetary gear 62 meshes together with the transmission gear 63, when the motor 49 (the transport driving roller 21) is counter rotated.

Further, the control section 48, which controls the rotation of the motor 49 (the transport driving roller 21) is capable of executing a skew correction mode, which causes a leading end of a sheets of paper to follow the transport driving roller 21 by switching the rotation of the motor 49 from regular rotation to counter rotation thereof for a predetermined period of time in a feeding mode, which feeds the sheets of paper from the front feeding device 10, and a movement amount of the planetary gear 62 when the motor 49 (the transport driving roller 21) is counter rotated for a predetermined period of time is set to be smaller than a movement amount to reach the mesh position from the separation position.

Additionally, in the abovementioned embodiment, an example in which the invention adopts the front feeding device 10 as the “first feeding unit” and the rear feeding device 7 as the “second feeding unit” is described, but, for example, the invention can adopt a configuration in which a plurality of front feeding devices 10 are provided in an up-down direction (a multi-tray configuration), and for example, a two-stage tray configuration.

### 3. Rear Feeding Device

Subsequently, the configuration of the rear feeding device 7 will be described in detail with reference to the drawings from FIG. 10 onwards.

Firstly, the rear feeding device 7 will be outlined with reference to FIGS. 10 and 11. In FIGS. 10 and 11, reference numeral 73 is a gear that obtains a driving force via a one-time clutch mechanism 69, the gear 73 is fixed to a shaft 37, rotates once only as a result of the function of the one-time clutch mechanism 69 during a feeding action, and transmits a driving force to various constituent elements of the rear feeding device 7. Additionally, the one-time clutch mechanism 69 will be further described later. In FIG. 11, the illustration of the face cam accommodation section 69 is omitted.

A gear 74 is fixed to the shaft 37, and a driving force is transmitted from the gear 74 to the gear 75. A cam section 75a is formed on the gear 75, the cam section 75a engages with an engagement section 36a, which is formed on a shaft 36, and causes the shaft 36 to rotate. That is, the cam section 75a causes the paper sheet return lever 35 to rotate.

In addition, a gear 76 meshes together with the gear 74, and a gear 79 meshes together with the gear 76. The gear 79 is provided in an unfixed manner so as to capable of mutually rotating with respect to the rotational shaft 30. A cam section 79a is formed on the gear 79, the cam section 79a engages with the hopper 34, and causes the hopper 34 to swing.

The driving force transmission from the gear 74 to the gear 75, and from the gear 74 to the gear 79 is set to a reduction ratio of 1:1, that is, when the gear 73 (the shaft 37) rotates a single time, the abovementioned gears rotate a single time according to the rotation of the gear 73 (the shaft 37) as a result of the function of the one-time clutch mechanism 69.

Meanwhile, a gear 77 meshes together with the gear 73, and a gear 78 meshes together with the gear 77. The gear 78 is fixed to an axial end of the rotational shaft 30, and is a gear that causes the rotational shaft 30, that is, the feeding roller 29, to rotate. In this instance, the driving force transmission to the gear 73, the gear 77 and the gear 78 is set to a reduction ratio of 1:α (α>1), that is, when the gear 73 (the shaft 37) rotates a single time, the rotational shaft 30, that is, the feeding roller 29, rotates more than a single time as a result of the function of the one-time clutch mechanism 69.

If the abovementioned configuration is summarized, the rear feeding device 7 is provided with the feeding roller 29 that delivers the sheets of paper, the hopper 34, which supports the sheets of paper in an inclined posture, which is capable of switching between a state that causes the feeding roller 29 to come into pressure contact with the sheets of paper as a result of swinging, and a state that causes the sheets of paper to be separated from the feeding roller 29, the cam 79a, which is a cam that engages with the hopper 34 and rotates by obtaining a driving force from the transmission gear 73, and which executes state switching of the hopper 34 a single time during a single rotation action, and a gear group (the gears 73, 77 and 78), which is a unit that transmits a driving force from the transmission gear 73 to the feeding roller 29, and which causes the feeding roller 29 to rotate a plurality of times during a single rotation action of the cam 79a. As a result of this, it is possible to reduce the diameter of the feeding roller 29, and therefore, it is possible to achieve miniaturization of the apparatus.

Next, the one-way latch mechanism 28 that the rear feeding device 7 is provided with will be described. As shown in FIGS. 12 and 13, the one-way latch mechanism 28 is configured to be provided with a fixed member 31, which is fixed to the rotational shaft 30, and a movable member 32, which fits together with the rotational shaft 30 in a manner in which the movable member 32 is capable of mutually rotating with respect to the rotational shaft 30.

FIG. 12 shows a state in which the rotational shaft 30 is driven. The arrow shows a rotational direction, and in this state, a hook 31a, which is formed on the fixed member 31, meshes together with a hook 32a, which is formed on the movable member 32, a stopper 32b, which is formed on the movable member 32, engages with a protrusion 29a of the feeding roller 29, and as a result of this, a rotational driving force is transmitted to the feeding roller 29.

FIG. 13 shows a state (a rotation cessation state) in which the rotational shaft 30 is not being driven, and a state on which the feeding roller 29 driven around by sheets of paper that are transported by the transport driving roller 21 (the arrow). In this state, the protrusion 29a of the feeding roller 29 is engaged with a stopper 32c of the movable member 32, and the movable member 32 is rotated, but the hook 32a, which is formed on the movable member 32 is separated from the hook 31a, which is formed on the fixed member 31, and the feeding roller 29 and the movable member 32 can rotate independently from the rotational shaft 30 and the fixed member 31.

If the abovementioned configuration is summarized, the rear feeding device 7 is provided with the feeding roller 29 that delivers the sheets of paper, the rotational shaft 30 on which the feeding roller 29 is provided, and the one-way latch mechanism 28 that allows idling of the feeding roller 29 with respect to the rotational shaft 30 when the sheets of paper that is delivered from the rear feeding device 7 are transported to the downstream side by the transport driving roller 21. As a result of this, it is possible to eliminate or reduce a load that the feeding roller 29 applies to the sheets of paper when the sheets of paper that are delivered from the rear feeding device 7 are transported to the downstream side by the transport driving roller 21, and therefore, it is possible to suitably perform medium transport using the transport driving roller 21.

Next, the one-time clutch mechanism 69 will be described. The one-time clutch mechanism 69 is provided with a gear 70, which, as shown in FIGS. 3 and 10, meshes together with the gear 63, a rotating body 72, which, as shown in FIG. 10, is fixed to an axial end of the rotating shaft 37, and a swinging ring 71, which is provided so as to be capable of swinging with respect to the rotating body 72.

The one-time clutch mechanism 69 generally switches between a state in which driving is transmitted from the gear 70 to the rotating body 72 (the rotating shaft 37) as a result of the swinging ring 71 swinging with respect to the rotating body 72, and a contrasting state in which the transmission is interrupted.

FIG. 15 is a view that shows a relationship between the swinging ring 71 and the gear 70, and hereinafter, description will be given with reference to FIGS. 10 and 15.

Firstly, in a driving transmission state, the gear 70, the swinging ring 71, the rotating body 72, and the rotating shaft 37 are a rotating body that rotates integrally with the same axial center. Among these components, the swinging ring 71 is provided on the rotating body 72 in a manner in which the swinging ring 71 is capable of swinging with a swinging center 71a as the center thereof, and as a result of this swinging, a clutch 71b, which is provided on the inner periphery thereof, switches between a state of meshing together with a transmission gear 70a (FIG. 15), and a state of being separated (not illustrated in the drawings).

An engagement protrusion 71c is formed on the outer periphery of the swinging ring 71, and the engagement protrusion 71c is capable of engaging with a lever, which is not illustrated in the drawings. When the engagement protrusion 71c is in a non-engaged state with respect to the lever, which is not illustrated in the drawings, as shown in FIG. 14, a driving transmission state is attained as a result of the clutch 71b engaging with the transmission gear 70a. Additionally, the swinging ring 71 is biased in a swinging manner in a direction in which the clutch 71b meshes together with the transmission gear 70a by a biasing unit, which is not illustrated in the drawings. When the engagement protrusion 71c engages with the lever, which is not illustrated in the drawings, a driving interruption state is attained as a result of the swinging ring 71 swinging in a direction in which the clutch 71b becomes separated from the transmission gear 70a. The basic configuration of the abovementioned clutch is the same as that of technology of the related art.

The characterizing feature of the present embodiment is that a plurality (two in the present embodiment) of the clutches 71b is provided. That is, as was described with reference to FIG. 11, a reduction ratio of the driving force transmission from the gear 73 to the gear 77 and the gear 78 is set to 1:α (α>1) so that the rotational shaft 30, that is, the feeding roller 29, rotates more than a single time when the gear 73 (the shaft 37) rotates a single time. Accordingly, a reaction force (torque) that the one-time clutch mechanism 69 is subjected to from the feeding roller 29 side is large, and there is a high risk that the clutch 71b will be damaged.

However, since a plurality of the clutches 71b are provided in the manner described above, it is possible to effectively suppress damage of the clutches 71b. Additionally, in the example that is shown in FIG. 15, two clutches 71b are provided, but more may be provided.

In addition, for the same reason, in addition to providing a plurality of clutches 71b, it is suitable to increase the tooth thickness of the clutch 71b.

In addition, as shown in FIG. 16, the strength of the clutch 71b may be improved by providing a flange 71d integrally with the clutch 71b.

The entire disclosure of Japanese Patent Application No. 2015-028642, filed Feb. 17, 2015 is expressly incorporated by reference herein.

What is claimed is:

1. A recording apparatus comprising:
a recording unit that performs recording on a medium;
a transport roller that transports the medium, and that rotates in a direction for transporting the medium to a downstream side when a motor is regularly rotated, and rotates in a direction for transporting the medium to an upstream side when the motor is counter rotated;
a first feeding unit that is capable of accommodating the medium, and that delivers the medium toward the transport roller when the motor is regularly rotated by obtaining a driving force from the motor;
a second feeding unit that is capable of accommodating the medium, and that delivers the medium toward the transport roller when the motor is counter rotated by obtaining a driving force from the motor;
a planetary gear mechanism that is configured to include a sun gear which rotates as a result of receiving the driving force of the motor, and a planetary gear which performs planetary motion around the sun gear, and that is configured such that the planetary gear is positioned in a separation position, in which the planetary gear is separated from a transmission gear that transmits a driving force to the second feeding unit, when the motor is regularly rotated, and such that planetary gear is positioned in a mesh position, in which the planetary gear meshes together with the transmission gear, when the motor is counter rotated; and
a control unit that controls the rotation time of the motor,
wherein a movement amount of the planetary gear when the motor is counter rotated for a predetermined period of time is set to be smaller than a movement amount to reach the mesh position from the separation position.

2. The recording apparatus according to claim 1,
wherein the setting of the movement amount of the planetary gear when the motor is counter rotated for a predetermined period of time is executed during a skew correction mode, which causes a leading end of the medium to follow the transport roller by switching from regular rotation of the motor to counter rotation thereof in a feeding mode, which feeds the medium from the first feeding unit.

3. The recording apparatus according to claim 2,
wherein the first feeding unit has a configuration that delivers the medium from a medium accommodation section, which accommodates the medium in a substantially flat manner, and
wherein the second feeding unit has a configuration that delivers the medium from a medium setting section, in which the medium is set with an inclined posture.

4. The recording apparatus according to claim 3, further comprising:
a carriage that is provided with the recording unit, and that is capable of moving in a direction that intersects a transport direction of the medium; and
a switching unit that switches between a transmission state in which the rotation of the motor is transmitted to the first feeding unit and the second feeding unit by engaging with the carriage, and an interruption state in which the transmission is interrupted,
wherein the control unit is provided with a normal feeding mode, which performs state switching of the switching unit each time a sheet of the medium is delivered from the first feeding unit by performing state switching of the switching unit via the carriage, and a continuous feeding mode, which continuously delivers a plurality of sheets of the medium from the first feeding unit while retaining the switching unit in the transmission state.

5. The recording apparatus according to claim 3,
wherein the second feeding unit is provided with
a feeding roller that delivers the medium,
a hopper that supports the medium in an inclined posture, that is capable of switching between a state in which the feeding roller comes into pressure contact with the medium as a result of swinging, and a state in which the medium is separated from the feeding roller, and configures the medium setting section,
a cam that engages with the hopper and rotates by obtaining a driving force from the transmission gear, and that executes state switching of the hopper a single time during a single rotation action, and
a gear group that transmits a driving force from the transmission gear to the feeding roller, and that causes the feeding roller to rotate a plurality of times during a single rotation action of the cam.

6. The recording apparatus according to claim 3,
wherein the second feeding unit is provided with
a feeding roller that delivers the medium,
a rotational shaft on which the feeding roller is provided, and
a clutch that allows idling of the feeding roller with respect to the rotational shaft when the medium that is delivered from the second feeding unit is transported to the downstream side by the feeding roller.
